(19) United States
(12) Patent Application Publication
(10) Pub. No.: US 2020/0180925 A1
(43) Pub. Date: Jun. 11, 2020

(54) PROTECTIVE BARRIER FOR A CONTROL PANEL

(71) Applicant: Control Shell Limited, Manchester Lancashire (GB)

(72) Inventor: John Reynolds, Manchester Lancashire (GB)

(73) Assignee: Control Shell Limited, Manchester Lancashire (GB)

(21) Appl. No.: 16/614,451

(22) PCT Filed: May 18, 2018
(86) PCT No.: PCT/GB2018/051350

§ 371 Date: Nov. 18, 2019

(30) Foreign Application Priority Data
May 18, 2017 (GB) 1708016.9

(51) Int. Cl. B66F 11/04; B66F 9/075; B60K 37/06; H01H 13/86; G05G 25/04

(52) U.S. Cl. CPC B66F 11/046; B66F 9/07504; H01H 2009/048; H01H 13/86; G05G 25/04; B60K 37/06

(57) ABSTRACT

The present invention relates to a mobile elevating work platform comprising a control panel, said control panel (6) comprising a protective barrier (13) on an outer surface thereof, wherein the protective barrier comprises an elastomer. The present invention also relates to a method for providing a control panel with a protective barrier (13), which comprises the steps of obtaining a three-dimensional profile of an outer surface of a control panel, creating a mould from the three-dimensional profile, providing an elastomer and shaping the elastomer in the mould, curing the elastomer to form the protective barrier and fitting the protective barrier to the control panel. The present invention also relates to a mobile elevating work platform (MEWP) comprising a control panel (6) and a rigid shell (26) for protecting the control panel.

### TECHNICAL FIELD OF THE INVENTION

The present invention relates to a protective barrier for a control panel, particularly a control panel of a mobile elevating work platform, and to a method for manufacturing the same.

### BACKGROUND TO THE INVENTION

Mobile elevating work platforms (MEWPs), also known as aerial work platforms (AWPs) are mechanical devices that allow inaccessible areas, usually at height, to be accessed by people and/or equipment. “Cherry picker”, “scissor lift” and diesel boom devices are well known examples of MEWPs and are generally used in the construction and telecommunication industries.

The position of the work platform is typically controlled by an operator using a control panel. The control panel may be located on the work platform itself which enables the operator on the work platform to control the position of the work platform. Alternatively, the position of the work platform may be adjusted by an operator at ground level using a control panel located at the base of the MEWP.

A known disadvantage of conventional MWEPs is that their control panels are susceptible to moisture ingress which is the most common cause of MWEP downtime. Further, moisture ingress to control circuits is also known to cause involuntary movement in MWEPs which is hazardous to both operators on the work platform and at ground level.

While efforts have been made to prevent the ingress of moisture into control panels, for instance by spraying control panels with aerosol sprays that contain a blend of waxes and oils, the thin films that are formed are not robust and can easily be washed away. Thus, such films can only be seen as being a temporary measure for preventing the ingress of moisture into control panels.

A further disadvantage of such thin films is that they offer little in the way of impact resistance, meaning that there is an increased risk that falling objects, e.g. branches from a tree or debris from a building site, could damage the control panel, leading to an extended period of downtime while the control panel is repaired.

It is an object of embodiments of the present invention to provide a protective barrier that prevents the ingress of moisture into control panels.

It is an object of embodiments of the present invention to provide a protective barrier that is resistant to oils and solvents.

It is an object of embodiments of the present invention to provide a protective barrier that exhibits good impact resistance to falling objects.

### SUMMARY OF THE INVENTION

According to a first aspect of the invention there is provided a mobile elevating work platform (MEWP) comprising a control panel, said control panel comprising a protective barrier on an outer surface thereof, wherein the protective barrier comprises an elastomer.

The protective barrier may comprise a thermoset elastomer. It was found that thermoset elastomers could be used successfully as protective barriers for control panels because they are strong, flexible and are capable of preventing moisture ingress into control panels. Further, protective barriers based on thermoset elastomers can be deformed under stress and can return to their original configuration once the stress is removed. This means that the protective barrier can be deformed (stretched) to fit to control panels of varying size and to fit around controllers, e.g. buttons, dials and ball top controllers, that extend radially outwardly from the outer surface of the control panel.

The thermoset elastomer may be a silicone elastomer. Silicone elastomers have been found to be particularly suitable for use as protective barriers in accordance with the present invention. In particular, it was found that silicone elastomers were particularly suitable for preventing moisture ingress and that they could be deformed, e.g. by stretching, and return to their original shape substantially without distortion. Unlike organic elastomers having a carbon-to-carbon polymeric backbone, silicone elastomers (having a silicon-to-carbon polymeric backbone) are less susceptible to ozone, UV, heat and other aging factors. This means that protective barriers based on silicone elastomers are particularly suitable for protecting control panels of MEWPs which are typically exposed to ozone, UV and heat by virtue of them being mainly used outside.

The elastomer may be transparent or substantially transparent. This allows the outer surface of the control panel, which may for instance comprise safety decals, to remain visible to the operator once the protective barrier has been applied.

The elastomer may be hydrophobic. The use of a hydrophobic elastomer was found to prevent water from spreading across the surface of the protective barrier. Thus, the possibility of water reaching and coming into contact with the control panel can be reduced significantly.

The protective barrier may have a thickness of between 1 and 5 mm, preferably between 1 and 2 mm. The thickness of the protective barrier may be thicker at the edges and/or corners of the control panel since these areas are especially susceptible to damage upon impact.

The operating temperature of the elastomer may be from −55° C. to 300° C. In the context of the present invention the term operating temperature means the temperature at which the elastomer can perform its function as a protective barrier once it has been applied onto the surface of the control panel. Since MEWPs are used in environments which can be very hot, e.g. in metal forging factories or in environments where the temperature may be 0° C. or less, a preferred operating temperature is between −10° C. and 40° C. In particular, the operating temperature may be between 5° C. and 25° C. This means that the control panel of the MEWP according to the present invention can be protected even when the MEWP is exposed to adverse or extreme weather conditions.

The electrical resistance of the elastomer may be from 1TΩ·m to 100TΩ·m. By using an elastomer with an electrical resistance within the aforementioned range the number of contact points between the operator and the machine is reduced and therefore the risk of the operator receiving electric shocks is minimised. It will be appreciated that the electrical resistance selected within the range will depend on the thickness of the protective barrier. For instance, elastomers with an increased electrical resistance may be used when producing thin protective barriers, whereas elastomers with lower electrical resistances can be used to form thicker protective barriers.

In order to fit the elastomeric protective barrier to the control panel it may be necessary to deform the elastomer prior to and/or during its application on to the control panel. It is important that the elastomer does not tear as the elastomer is deformed since this can be costly and will delay the fitting of the elastomer to the control panel. In accordance with the present invention the elastomer may have an elongation at break of at least 100%. This ensures that the integrity of the elastomer will not substantially deteriorate as it is deformed and fitted to a control panel. Moreover, if the elongation at break is below 100%, cracks or like may form as the elastomer is deformed, and if these cracks go unnoticed, there is an increased risk of water ingress and MEWP downtime. Preferably the elastomer has an elongation at break of at least 400%. In particular the elongation at break may be between 600% and 800%.

The elastomer preferably has a hardness of at least 00-20 on the shore hardness scale. Elastomers having a hardness below 00-20 may not exhibit sufficient impact resistance to protect the control panel from falling objects such as branches or debris from a building site, which could result in the control panel being damaged from the impact. By using an elastomer having a hardness of not less than 00-20, the elastomer will exhibit improved durability relative to elastomers having a hardness below this lower limit. This means that the elastomer will be able to perform its function of protecting the control panel from falling objects over a greater period of time before it has to be replaced. In particular the hardness may be between 00-30 and A-20.

Elastomers of the present invention may have flame retardant properties such that the control panel can be protected when the MEWP is being used in industrial environments where activities such as metal cutting, burning and welding may take place.

The elastomer once cured may also be resistant or substantially resistant to oils, solvents or other chemicals. The use of an elastomer having such properties means that the control panel may be protected from spillages and from chemicals contained in products that are commonly used to maintain and clean the MEWP.

The elastomer is preferably capable of absorbing vibrations that may arise from the MEWP's engine or a motor when in use. This has the advantage that vibration induced conditions that are known to affect the tendons, muscles, bones and the nervous system of an operator can be prevented or the extent of the condition can be minimised.

The MEWP may comprise at least two protective barriers. For instance, a further protective barrier may be provided on the protective barrier if the integrity of the protective barrier is compromised. The further protective barrier can be provided to cover the compromised part of the first protective barrier only, e.g. in the form of a patch. The further protective barrier may be the same as the first protective barrier and therefore the second protective barrier may, as appropriate, incorporate any or all features described in relation to the protective barrier provided adjacent the control panel. Alternatively, the further protective barrier may differ from the protective barrier provided adjacent the control panel and may be tailored to suit the needs of a particular environment. For instance, if the MEWP is to be mainly used in coastal areas where moisture in the air contains a relatively high salt content, then the further protective barrier may be adapted to contain additives such as corrosion inhibitors to prevent against or substantially reduce corrosion of protective barrier.

In another embodiment of the invention the MWEP may comprise a protective casing or “shell”. The protective shell may comprise a first protective shell component, a second protective shell component and a thermally insulating material disposed therebetween. A suitable adhesive may be used to bond the thermally insulating material to the first and second shell components. The first and second protective shell components are preferably made of a material that is rigid so as to protect the control panel from falling objects. Preferably the first and second protective shell components are made from a thermoplastic material which allows the first and second shell components to be made by a vacuum forming process. Vacuum forming is a relatively inexpensive forming process and therefore offers an inherent cost benefit to the manufacturer of the protective shell components.

The protective shell may be pivotally connected at one end to the control panel so that the protective shell is moveable between open and closed positions. For instance, the protective shell may be moved to its closed position when the MWEP is not in use and may be moved to its open position when the operator requires access to the control panel. The protective shell may be pivotally connected to the control panel by way of a hinge. Alternatively, the protective shell may not be connected to the control panel and can be removed from and placed on the control panel as required.

The protective shell may comprise fastening means in order to secure the protective shell to the control panel when the protective shell is in its closed position or when the protective shell is placed over the control panel. The fastening means may be in form of a buckle or may comprise snap fastening means, for instance in the form of interlocking discs made of metal or a plastics material.

According to a second aspect of the invention there is provided a method for providing a control panel with a protective barrier, which comprises the steps of obtaining a three-dimensional profile of an outer surface of a control panel, creating a mould from the three-dimensional profile, providing an elastomer and shaping the elastomer in the mould, curing the elastomer to form the protective barrier and fitting the protective barrier to the control panel.

The method according to the second aspect of the invention is suitable for providing the MEWP control panel of the first aspect of the invention with a protective barrier. The method according to the second aspect may therefore, as appropriate, incorporate any or all features described in relation to first aspect of the invention.

The three-dimensional profile may obtained by taking an impression of the outer surface of the control panel. This may be achieved by providing an impression material on an outer surface of the control panel and thereafter applying sufficient pressure to the impression material such that an impression of the control panel surface is formed on a surface of the impression material facing the control panel. Pressure may be provided my mechanical means and the impression material may comprise a plastics or any other suitable material.

In an alternative embodiment of the invention the three-dimensional profile may be obtained using computer-aided design software.

In another embodiment of the invention the elastomer may be shaped using an injection moulding process.

According to a third aspect of the invention there is provided a mobile elevating work platform (MEWP) comprising a control panel and a rigid shell for protecting the control panel. The rigid shell may comprise any or all of the features of the rigid shell described in relation to the first and second aspects of the invention.

### DETAILED DESCRIPTION OF THE INVENTION

In order that the invention may be more clearly understood embodiments thereof will now be described, by way of example only, with reference to the accompanying drawings, of which:

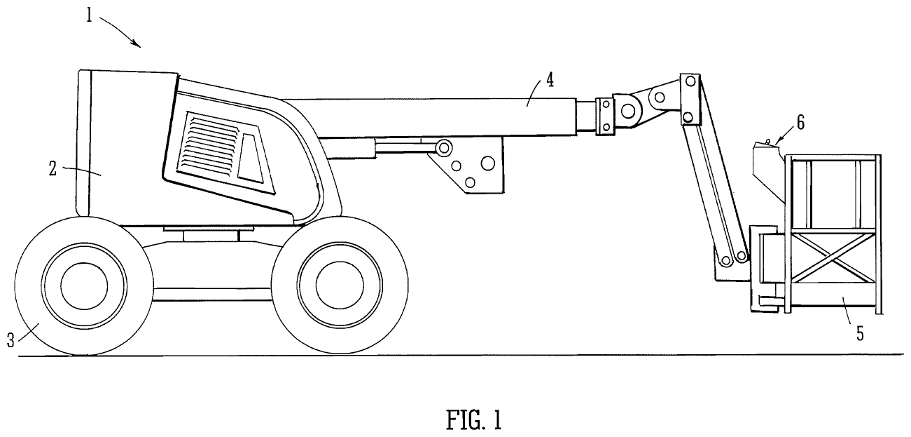

FIG. 1 shows a perspective view of a mobile elevated work platform

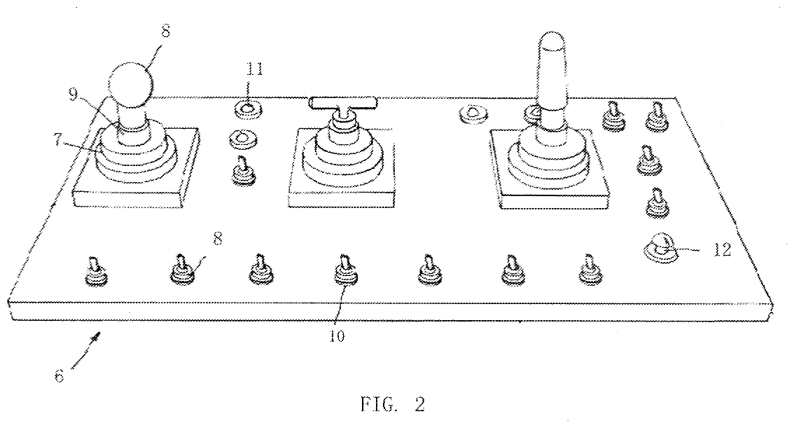

FIG. 2 shows a perspective view of a mobile elevated work platform control panel.

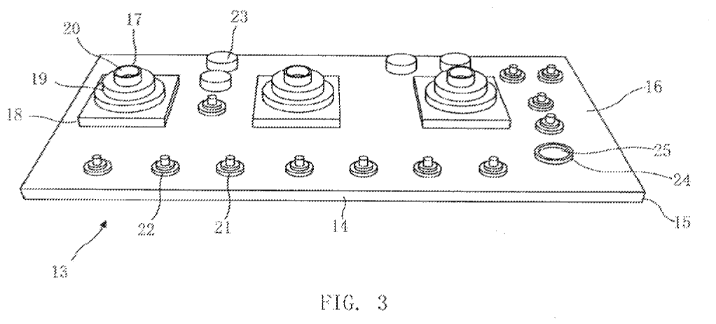

FIG. 3 shows a perspective view of a protective barrier according to the present invention.

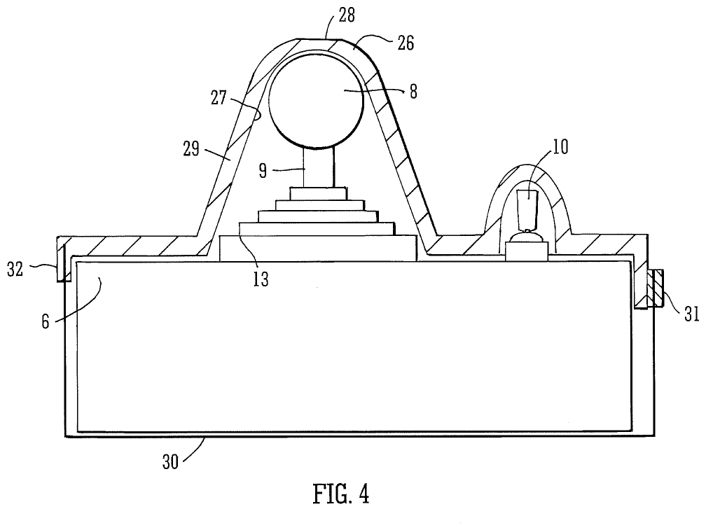

FIG. 4 shows a cross-section of a control panel provided with a protective barrier and with a protective shell.

With reference to FIG. 1 there is shown a mobile elevated work platform (MWEP) 1. The MWEP 1 has a drivable vehicle body 2 having wheels 3 and an extendable boom 4 mounted at one end to the vehicle body 3. A basket 5 is mounted onto the free end of the boom 4 away from the vehicle body 3. The basket 5 is provided with a set of controls (not shown) in the form of a control panel 6 so that, in use, an operator standing in the basket 5 can raise, lower, extend or rotate the boom 4 so as to move the basket 5 to the desired location.

FIG. 2 shows a control panel 6 commonly found in a basket of a diesel boom type MWEP 1. The general movement of the basket 5 is controlled by a ball-and-stick controller 7. The base of the ball 8 and stick 9 controller 7 is protected by a flexible casing which extends partly along the stick 9 in the direction of the ball 8. The control panel 6 also comprises a plurality of toggle switches 10 which enables the operator to switch between different operating modes, e.g. between raising and extending modes when optimising the position of the basket 5. The control panel 6 additionally comprises a plurality of indicator lights 11 that are important for hazard identification as well as for control identification.

A manually operable stop button 12 is also provided on the control panel 6 so that the operator may cut the power supply to the MWEP 1 when pressed, for instance in the event of an accident or if the operator loses control of the MWEP 1.

In accordance with the present invention the control panel of the diesel boom (or any other MWEP) is provided with a protective barrier 13. The protective barrier 13 is manufactured by first mapping the contours of the control panel 6 surface using computer-aided design (CAD) software so as to obtain a three-dimensional profile of the control panel 6. The three-dimensional profile is then used to produce a mould, typically made of steel or aluminium.

The protective barrier is formed using an injection moulding process. The injection moulding process comprises the steps of providing a first amount of a silicone compound into a first vessel and providing a first amount of a liquid catalyst into a second vessel. Metering units are then used to pump the silicone compound and the liquid catalyst into a mixing section at where they are mixed to form a homogeneous mixture. The silicone compound and the liquid catalyst are pumped at a pressure of 5000 psi. Additives such as corrosion inhibitors provided in a third vessel may optionally be pumped into the mixing section before pumping the silicone compound and the liquid catalyst into the same. A cooling jacket surrounds the mixing section in order to retard the curing process, which begins as soon as the silicone compound and the liquid catalyst come into contact. The homogeneous mixture is then pumped into a cooled injection unit which is used to pump the homogenous mixture under pressure through a cooled sprue and into a mould having a temperature between 180° C. and 200° C. The heated mould promotes the cross-linking reaction between silicone polymer chains, which causes the silicone compound to solidify and results in the formation of the protective barrier once cooled. The protective barrier is then removed from the mould and the cycle is repeated so as to produce multiple protective barriers.

A protective barrier 13 according to the present invention is best shown in FIG. 3. The protective barrier 13 is substantially rectangular in shape and has a thickness of between 1 and 2 mm, with the protective barrier 13 being thicker at the edges 14 corner points 15 relative to the thickness of the front face 16. The front face 16 of the protective barrier is substantially transparent or translucent so as to enable safety and control decals and the like to be easily viewed by an operator. The front face 16 of the protective barrier 13 follows the contours of the control panel 6 and therefore the protective barrier 6 comprises a plurality of hollow protrusions capable of at least partly housing the controls of the control panel.

In this embodiment the protective barrier 13 comprises a series of first hollow protrusions 17 capable of at least partly covering the ball 8 and stick 9 controller 7. The first hollow protrusions 17 comprise a substantially square hollow base 18 and a plurality of first hollow tiers 19 provided thereon. The first hollow tiers 19 being annular in shape and reducing in cross-sectional area from the lowermost tier to the uppermost tier. The uppermost tier comprises an aperture 20 in an upper surface thereof so as to allow the ball 8 and at least part of the stick 9 to pass therethrough as the protective barrier 13 is provided on the control panel 6. The protective barrier 6 also comprises a series of second hollow protrusions 21 for covering the toggle switches 10 on the control panel 6. The second hollow protrusions 21 also comprise a second hollow tier arrangement 22 with the cross-sectional areas reducing from the lowermost tier adjacent the front face 16 to the uppermost tier. The protective barrier 13 further comprises a plurality of third hollow protrusions 23 that are capable of covering indicator lights 11 and a fourth hollow 24 protrusion for covering the emergency stop button 12. The third and fourth hollow protrusions (23, 24) comprise a substantially cylindrical cross-section, and in the case of the fourth hollow protrusion 24, it additionally comprises a beaded rim 25 which allows free movement of the emergency stop switch 12.

As best shown in FIG. 4, the control panel is provided with a protective shell 26. The protective shell 26 comprises a first inner protective shell component 27, a second outer protective shell component 28 and a 5 mm thick thermally insulating material 29 provided therebetween. In this embodiment the thermally insulating material is a phenolic foam. The thickness of the first and second protective shell components (27, 28) is 2-3 mm. In use, the protective shell 26 is placed over the control panel 6 and is secured to the control panel 6 by means of a strap 30 and a buckle snap fastener 31. The strap 30 is fixedly connected to a lip 32 which surrounds the perimeter of the control panel 6 and extends in a direction substantially perpendicular to the control panel's 6 upper surface. The buckle snap fastener 31 is also secured to the lip 32 at a location opposite the fixedly connected strap 30. To secure the protective shell 26 to the control panel 6, the free end of the strap 30 is passed around the underside of the control panel 6 and then secured to the buckle snap fastener 32.

The first and second shell components (27, 28) each comprise a thermoplastic material such as polyester and are formed using a vacuum forming process. A mould made of steel, aluminium or wood is placed onto an upper surface of a platen. A sheet of thermoplastic material having a surface area greater than that of the mould is then secured to the vacuum forming apparatus, above the mould, by suitable clamping means. The thermoplastic sheet material is then softened using suitable heating means provided above and parallel to the thermoplastic sheet. The platen comprises a plurality of apertures which allows air to be removed from below the thermoplastic sheet using suitable vacuum means such as a vacuum pump. Atmospheric pressure then pushes the softened thermoplastic sheet onto the mould to form the protective shell component (27 or 28 as appropriate).

The above embodiment is described by way of example only. Many variations are possible without departing from the scope of the invention.

1. A mobile elevating work platform comprising a control panel, said control panel comprising a protective barrier on an outer surface thereof, wherein the protective barrier comprises an elastomer.

2. Mobile elevating work platform according to claim 1, wherein the elastomer is a thermoset elastomer.

3. Mobile elevating work platform according to claim 1, wherein the elastomer is a silicone elastomer.

4. Mobile elevating work platform according to claim 1, wherein the elastomer is substantially transparent.

5. Mobile elevating work platform according to claim 1, wherein the elastomer is hydrophobic.

6. Mobile elevating work platform according to claim 1, wherein the operating temperature of the elastomer is from −55° C. to 300° C.

7. Mobile elevating work platform according to claim 1, wherein the electrical resistance of the elastomer is from 1TΩ·m to 100TΩ·m.

8. Mobile elevating work platform according to claim 1, wherein the elastomer has an elongation at break of at least 100%.

9. Mobile elevating work platform according to claim 1, wherein the elastomer has a shore hardness of at least 00-20.

10. Mobile elevating work platform according to claim 1, wherein the control panel comprises a further protective barrier.

11. Mobile elevating work platform according to claim 10, wherein the further protective barrier is in the form of a patch.

12. Mobile elevating work platform according to claim 10, wherein the further protective barrier comprises a rigid shell.

13. Mobile elevating work platform according to claim 12, wherein the rigid shell comprises a thermoplastic material.

14. Mobile elevating work platform according to claim 12, wherein the rigid shell comprises an insulating material.

15. Mobile elevating work platform according to claim 14, wherein the insulating material is disposed between a first thermoplastic material layer and a second thermoplastic material layer.

16. Mobile elevating work platform according to claim 13, wherein the thermoplastic material comprises a polyester.

17. Mobile elevating work platform according to claim 14, wherein the insulating material comprises a phenolic foam.

18. Mobile elevating work platform according to claim 12, wherein the rigid shell is pivotally connected at one end to the control panel and is moveable between open and closed positions.

19. Mobile elevating work platform according to claim 12, wherein the rigid shell comprises fastening means for securing the rigid shell to the control panel.

21-30. (canceled)

31. Mobile elevating work platform according to claim 12, wherein the rigid shell is configured to fit around a plurality of controllers extending from the control panel.
